(19) United States
(12) Patent Application Publication
(10) Pub. No.: US 2010/0167152 A1
(43) Pub. Date: Jul. 1, 2010

(54) Fuel Cell System

(76) Inventors: Shinji Hocho, Aichi-ken (JP); Yasushi Matsuhiro, Aichi-ken (JP); Keiichi Nakata, Shizuoka-ken (JP)

Correspondence Address: KENYON & KENYON LLP, 1500 K STREET N.W., SUITE 700, WASHINGTON, DC, 20005, US

(21) Appl. No.: 11/990,124

(22) PCT Filed: Aug. 7, 2006
(86) PCT No.: PCT/JP2006/316058

§ 371 Date: May 15, 2008

(30) Foreign Application Priority Data
Aug. 8, 2005 (JP) 2005-229295

(51) Int. Cl. H01M 8/04

(52) U.S. Cl. 429/444

(57) ABSTRACT

Disclosed is a fuel cell system (100) comprising a solid polymer fuel cell, wherein a cathode off-gas containing moisture which is discharged from a cathode of a fuel cell stack (10) is circulated and supplied back to the cathode. In addition, when flooding occurs in this fuel cell stack (10), an air pump (42), a circulation throttle (44), a supply throttle (46) and a back pressure control valve (38) are controlled for increasing the circulation amount of the cathode off-gas, thereby discharging the excess moisture. Consequently, flooding problems can be resolved in this fuel cell system while surely keeping the electrolyte membrane wet.

### TECHNICAL FIELD

The present invention relates to a fuel cell system furnished with a solid polymer electrolyte fuel cell.

### BACKGROUND ART

Fuel cells that generate electricity through electrochemical reaction of hydrogen and oxygen have been noted as an energy source in the past. These fuel cells include solid polymer electrolyte fuel cells which employ a solid polymer membrane as the electrolyte membrane. In order to obtain the desired electricity generation capability with a solid polymer electrolyte fuel cell of this kind, it is necessary to keep the electrolyte membrane in a properly wetted condition, and maintain a proper level of proton conductivity by the electrolyte membrane. For this reason, in fuel cell systems equipped with solid polymer electrolyte fuel cells it is necessary to humidify the electrolyte membrane during operation.

Recently, there has been proposed a technology whereby the product water which evolves in the fuel cell during electricity generation, i.e., through electrochemical reaction of hydrogen and oxygen, is reused for the purpose of humidifying the electrolyte membrane, thereby improving the energy efficiency of the fuel cell system. For example, JP 8-500931A and JP 9-312164A disclose technologies for humidifying the electrolyte membrane by circulating and re-supplying to the cathode the cathode off-gases containing product water which are expelled from the cathode.

On the other hand, if excess moisture is present in proximity to the electrolyte membrane, flooding will occur. Specifically, diffusion of the reactant gases to the electrolyte membrane will be hampered by the excess moisture, lowering the electricity generation capability of the fuel cell. As a technology for eliminating this flooding, JP 2004-152532A for example, discloses a technology whereby, when flooding has occurred, the flow of gas supplied to the fuel cell from the outside is increased to expel the excess moisture.

In a fuel cell system which humidifies the electrolyte membrane by circulating and re-supplying to the cathode the cathode off-gases which contain product water expelled from the cathode of the fuel cell, as taught in the aforementioned JP 8-500931A and JP 9-312164A, in order to eliminate flooding it would be possible to implement the technology disclosed in the aforementioned JP 2004-152532. However, in this case, if the flow of gas supplied to the fuel cell from the outside is merely increased, there was a risk that the electrolyte membrane will dry out excessively, and that the electricity generation capability of the fuel cell will drop. Accordingly, there is a need to eliminate flooding while suppressing drying out of the electrolyte membrane and maintaining a wetted state.

### DISCLOSURE OF THE INVENTION

The present invention is intended to solve the aforementioned problem, and has as an object to eliminate flooding while maintaining the electrolyte membrane in a wetted state in a fuel cell system furnished with solid polymer electrolyte fuel cells.

To solve the aforementioned problem at least in part, the following configuration is employed in the present invention.

The fuel cell system of the present invention comprises: a fuel cell employing a solid polymer electrolyte as the electrolyte membrane; a supply line for supplying oxidant gas to the cathode of the fuel cell; a circulation line for circulating to the supply line cathode off-gases that were expelled from the cathode; a circulating gas flow regulator for regulating the flow of the cathode off-gases circulating through the circulation line; a flooding detector for detecting that flooding occur in the fuel cell; and a controller for controlling the circulating gas flow regulator. When flooding is detected by the flooding detector, the controller controls the circulating gas flow regulator so that the flow of the cathode off-gases circulating through the circulation line is greater than when flooding does not occur.

By so doing, while utilizing the cathode off-gases containing moisture as well as appropriately controlling the circulating amount thereof to humidify the electrolyte membrane, excess moisture can be expelled from the fuel cell when flooding occurs in the fuel cell. Consequently, in a fuel cell system furnishes with solid polymer electrolyte fuel cells, the electrolyte membrane can be maintained in a wetted condition, while expelling excess moisture and eliminating flooding.

In the aforementioned fuel cell system, the circulating gas flow regulator may include a first flow regulating valve disposed on the circulation line, for regulating the flow of cathode off-gases circulating through the circulation line; and a pump disposed on the supply line downstream from the junction portion of the supply line and the circulation line. When flooding is detected by the flooding detector, the controller may increase the revolution speed of the pump to faster and increases the opening of the first flow regulating valve greater than when flooding does not occur.

In the aforementioned fuel cell system, the circulating gas flow regulating portion may further include a second flow regulating valve disposed on the supply line upstream from the junction portion of the supply line and the circulation line, for regulating the flow of the oxidant gas. When flooding is detected by the flooding detector, the controller may decrease the opening of the second flow regulating valve less than when flooding has not occurred.

By so doing, the circulating amount of moisture-containing cathode off-gases can be increased when flooding occurs in the fuel cell.

Besides being constituted as the fuel cell system described above, the present invention can also be constituted as a fuel cell system control method invention. Also, the invention can be reduced to practice in various other modes such as a computer program for realizing the above; a recording medium having the program recorded thereon; or a data signal containing the program and embodied in a carrier wave. In these respective embodiments it is possible to implement the various supplemental elements shown previously.

Where the present invention is constituted as a computer program, a recording medium having the program recorded thereon, etc., it may constitute the entire program for controlling operation of the fuel cell system, or constitute only those portions which accomplish the functions of the present invention. Various recording media can be used as the recording medium, such as a flexible disk, CD-ROM, DVD-ROM, magnetooptical disk, IC card, ROM cartridge, punch card, printed material having a bar code or other symbol imprinted thereon, a computer internal storage device (e.g. RAM, ROM, or other memory) or external memory device, or various other such computer-readable media.

### BRIEF DESCRIPTION OF THE DRAWINGS

FIG. 1 is an illustration showing a simplified configuration of a fuel cell system 100 as a first embodiment of the present invention;

FIG. 2 is a flowchart depicting the flow of flooding elimination control; and

FIG. 3 is an illustration showing a simplified configuration of a fuel cell system 100A as a modification example;

### BEST MODE FOR CARRYING OUT THE INVENTION

The embodiments of the present invention will be described below, in the following order.
A. Configuration of Fuel Cell System:
B. Operation Control:
C: Modification Examples:

### A. Configuration of Fuel Cell System

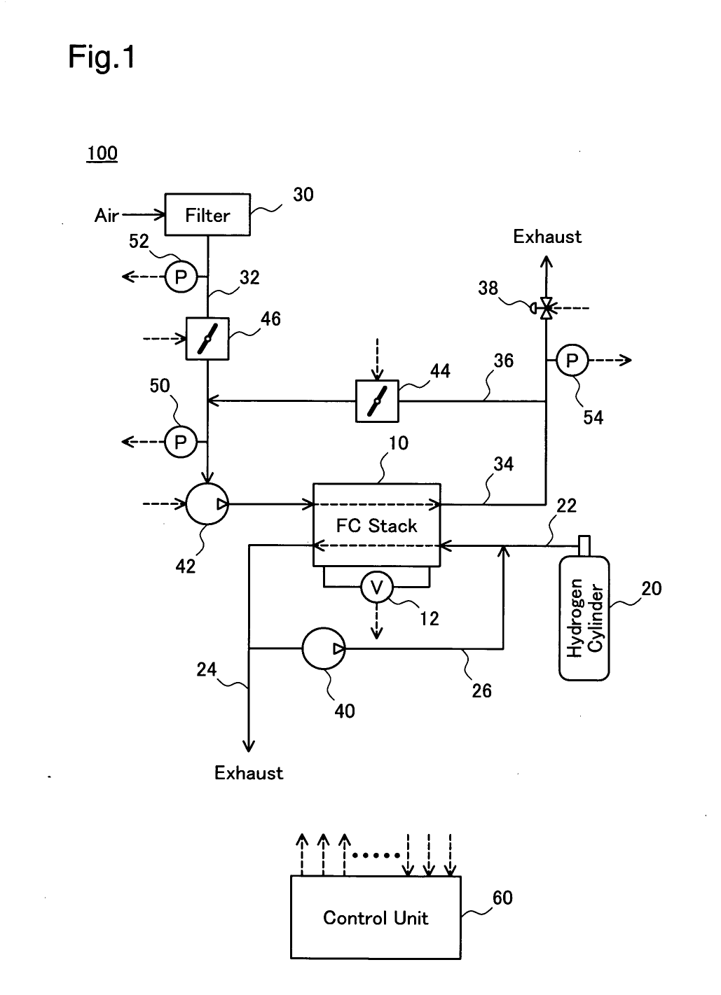

FIG. 1 is an illustration showing a simplified configuration of a fuel cell system 100 as a first embodiment of the present invention. A fuel cell (FC) stack 10 is a stack of multiple stacked cells for generating electricity through the electrochemical reaction of hydrogen and oxygen. Each cell is constituted by a hydrogen electrode (hereinafter termed the “anode”) and an oxygen electrode (hereinafter termed the “cathode”) positioned sandwiching an electrolyte membrane having proton conductivity. In this embodiment, solid polymer type cells utilizing a solid polymer electrolyte membrane of NAFION™ or the like as the electrolyte membrane are used. A voltage sensor 12 for measuring cell voltage is installed in the fuel cell stack 10.

The anodes of the fuel cell stack 10 are supplied with hydrogen fuel gas from a hydrogen cylinder 20 via a line 22. Instead of a hydrogen cylinder 20, hydrogen could be generated by a reforming reaction of a starting material such as an alcohol, hydrocarbon, aldehyde, etc., and supplied to the anode.

The exhaust gases expelled from the anode (hereinafter termed the “anode off-gases”) are expelled to the outside through a line 24. A line 26 for circulating the anode off-gases is connected to the line 22 and the line 24. A circulating pump 40 is installed on this line 26, and by operation thereof the anode off-gases can be circulated so that hydrogen contained in the anode off-gases and unconsumed by the fuel cell stack 10 can be re-used. While omitted from the drawings and description, various valves, pressure sensors, etc. may be optionally installed on the lines.

The cathodes of the fuel cell stack 10 are supplied with air as the oxidant gas via a filter 30 and a line 32. An air pump 42 is installed on the line 32, and by operation thereof air is supplied to the cathode. The line 32 corresponds to the supply line in the present invention.

The exhaust gases expelled from the cathode (hereinafter termed the “cathode off-gases”) are expelled to the outside through a line 34 and a back pressure control valve 38. A line 36 for circulating the cathode off-gases is connected to the line 32 and the line 34. As mentioned earlier, since the fuel cell stack 10 of the present embodiment utilizes a solid polymer membrane as the electrolyte membrane, it is necessary to humidify the electrolyte membrane in order to maintain appropriate proton conductivity of the electrolyte membrane and achieve the desired electricity generating capability. Since the cathode off-gases contain product water evolved through electricity generation by the fuel cell stack 10, humidification of the electrolyte membrane can be carried out by supplying these cathode off-gases to the cathode. The line 36 corresponds to the circulation line in the present invention.

As illustrated, a supply throttle 46 for controlling the amount of air supplied to the fuel cell stack 10 is disposed upstream from the junction portion of the line 32 with the line 36. A pressure sensor 52 for measuring pressure inside the line 32 between the filter 30 and the supply throttle 46 is disposed between the supply throttle 46 and the filter 30 of the line 32. A pressure sensor 50 is also disposed between the air pump 42 and the junction portion of the line 32 with the line 36. A pressure sensor for measuring back pressure is disposed on the line 34. A circulation throttle 44 for controlling the amount of circulating cathode off-gases is disposed on the line 36. The air pump 42, the circulation throttle 44, and the supply throttle 46, which can control the amount of circulating cathode off-gases through control of the speed of the air pump 42, the opening of the circulation throttle 44, and the opening of the supply throttle 46, correspond to the circulating gas flow regulator in the present invention.

Operation of the fuel cell system 100 is controlled by a control unit 60. The control unit 60 is constituted as a microcomputer equipped with an internal CPU, RAM, and ROM, and controls operation of the system in accordance with a program stored in ROM. In the drawing, examples of signals input and output to the control unit for the purpose of realizing this control are shown by broken lines.

Sensor signals from the pressure sensors 50, 52, 54 and from the voltage sensor 12 for example can be cited as input signals. Control signals for the back pressure control valve 38, the air pump 42, the circulation throttle 44, and the supply throttle 46 for example can be cited as output signals.

### B. Operation Control

Flooding elimination control, which is executed to eliminate flooding when this has occurred in the fuel cell stack 10, will be discussed below. Flooding refers to a phenomenon whereby product water condenses in proximity to the electrolyte membrane, with the excess moisture hampering diffusion of the reactant gases to the electrolyte membrane, lowering the electricity generation capability of the fuel cell.

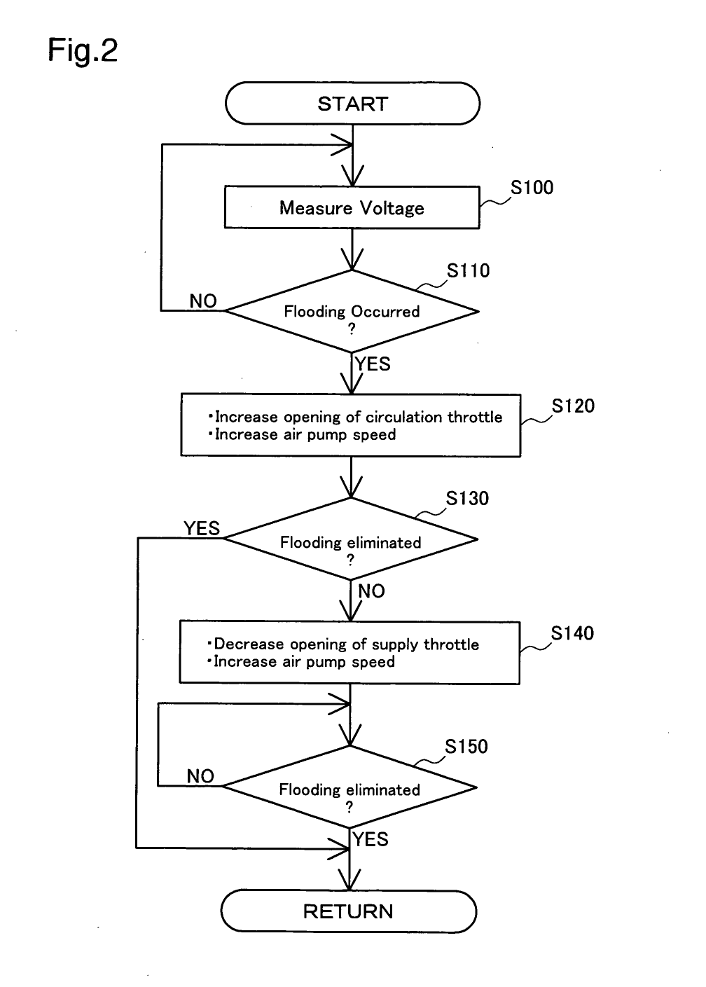

FIG. 2 is a flowchart depicting the flow of flooding elimination control. This control is control that the CPU of the control unit 60 carries out as-needed, during operation of the fuel cell system 100.

First, the CPU, through the voltage sensor 12, measures cell voltage of the fuel cell stack 10 (Step S100). Then, on the basis of the voltage value, it decides whether flooding has occurred in the fuel cell stack 10 (Step S110). For example, it will decide that flooding has occurred in the event that cell voltage is equal to or less than a prescribed value.

In the event it was decided in Step S110 that flooding has occurred, the CPU will increase the opening of the circulation throttle 44, as well as increasing the speed of the air pump 42 (Step S120). By so doing, the circulating amount of cathode off-gases will be increased, the flow speed will be increased, and expulsion of excess moisture in proximity to the electrolyte membrane of the fuel cell stack 10 can be accelerated. At this time, the CPU will control the opening of the circulation throttle 44 and the speed of the air pump 42, so that the output of the pressure sensor 52 becomes constant. The CPU will also monitor the output of the pressure sensor 54 and control the opening of the back pressure control valve 38, so that back pressure becomes constant. By making the opening of the back pressure control valve 38 larger and controlling back pressure to a lower level, expulsion of moisture from the fuel cell stack 10 can be accelerated further.

Next, through the voltage sensor 12, the CPU will measure cell voltage of the fuel cell stack 10, and in the same manner as in Step S110 will decide whether flooding has been eliminated (Step S130). In the event that flooding has been eliminated (Step S130: YES), flooding elimination control will terminate.

In Step S130, in the event that flooding has not been eliminated (Step S130: NO), the CPU will reduce the opening of the supply throttle 46, as well as further increasing the speed of the air pump 42 (Step S140). By so doing, the amount of circulating cathode off-gases will be increased without increasing the amount of air supplied as the oxidant gas, the flow speed in total will be increased, and expulsion of excess moisture in proximity to the electrolyte membrane of the fuel cell stack 10 can be accelerated further. At this time, the CPU will control the opening of the supply throttle 46 and the speed of the air pump 42, so that the output of the pressure sensor 52 becomes constant. The CPU will also monitor the output of the pressure sensor 54 and control the opening of the back pressure control valve 38, so that back pressure becomes constant.

Then, through the voltage sensor 12, the CPU will again measure cell voltage of the fuel cell stack 10, and in the same manner as in Step S110 will decide whether flooding has been eliminated (Step S150). In the event that flooding has not been eliminated, the operation will continue while increasing the circulating amount of cathode off-gases, until eliminated (Step S150: NO). In the event that flooding has been eliminated (Step S150: YES), flooding elimination control will terminate.

According to the fuel cell system 100 of the present embodiment described above, by circulating moisture-containing cathode off-gases and supplying the cathode, humidification of the electrolyte membrane of the fuel cell stack 10 can be carried out, while increasing the circulating amount of cathode off-gases to expel excess moisture when flooding has occurred in the fuel cell stack 10, so that flooding can be eliminated.

### C: Modification Examples

While an embodiment of the present invention was described above, the present invention is not limited in any way by such an embodiment, and may be reduced to practice in various forms without departing from the spirit thereof. The following modification examples would be possible, for example.

### C1: Modification Example 1

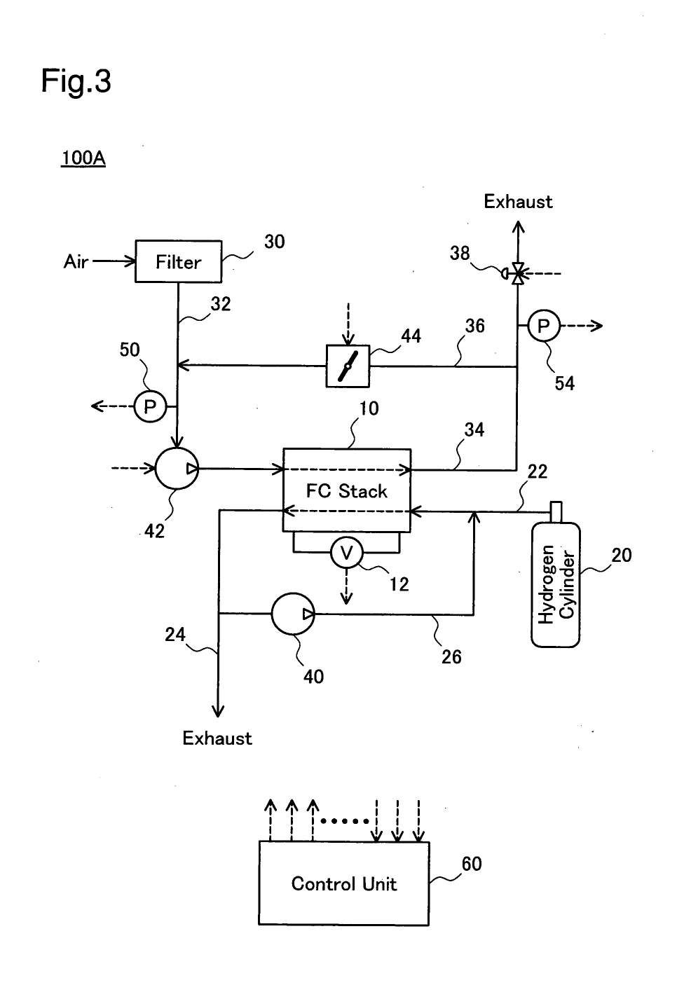

FIG. 3 is an illustration showing a simplified configuration of a fuel cell system 100A as a modification example. This fuel cell system 100A is the same as the fuel cell system 100 except for not being provided with the supply throttle 46 and the pressure sensor 52 in the fuel cell system 100 of the above embodiment. In flooding elimination control in this modification example, the processes of Step S130 and of Step S140 in the flowchart shown in FIG. 2 are omitted.

With the fuel cell system 100A of the present modification example, like the fuel cell system 100 of the above embodiment, by circulating the moisture-containing cathode off-gases and supplying them to the cathode, while carrying out humidification of the electrolyte membrane of the fuel cell stack 10, the circulating amount of the cathode off-gases can be increased to expel excess moisture when flooding has occurred in the fuel cell stack 10, eliminating flooding.

### C2: Modification Example 2

In the fuel cell system 100A of the preceding modification example, a circulation pump may be provided in place of the circulation throttle 44, and this may be controlled. Specifically, in the event of a decision that flooding has occurred, the CPU will increase the speed of the air pump 42, and also increase the speed of the circulation pump. By so doing, the circulating amount of cathode off-gases will be increased, the flow speed will be increased, and expulsion of excess moisture in proximity to the electrolyte membrane of the fuel cell stack 10 can be accelerated.

### C3: Modification Example 3

In the embodiment discussed previously, in Step S150 of the flooding elimination control shown in FIG. 2, in the event that flooding is not eliminated, the operation of increasing the circulating amount of cathode off-gases continues as-is; however, the present invention is not limited to this. For example, it would also be acceptable to return to Step S120, further increase the opening of the circulation throttle 44, and further increase the speed of the air pump 42. It would also be acceptable to return to Step S140, further decrease the opening of the supply throttle 46, and further increase the speed of the air pump 42.

### C4: Modification Example 4

In the embodiment discussed previously, the decision as to whether flooding has occurred in the fuel cell stack 10 is made on the basis of cell voltage detected by the voltage sensor 12, but is not limited to this. For example, would also be acceptable to measure the AC impedance of the fuel cell stack 10 using an impedance meter, and to decide on the basis of the measured value.

1. A fuel cell system comprising:
a fuel cell employing a solid polymer electrolyte as the electrolyte membrane;
a supply line for supplying oxidant gas to the cathode of the fuel cell;
a circulation line for circulating to the supply line cathode off-gases that were expelled from the cathode;
a circulating gas flow regulator for regulating the flow of the cathode off-gases circulating through the circulation line;
a flooding detector for detecting that flooding occurs in the fuel cell; and
a controller for controlling the circulating gas flow regulator;
wherein when flooding is detected by the flooding detector, the controller controls the circulating gas flow regulator such that the flow of the cathode off-gases circulating through the circulation line is greater than when flooding does not occur.

2. The fuel cell system according to claim 1 wherein the circulating gas flow regulator comprises:
a first flow regulating valve disposed on the circulation line, for regulating the flow of cathode off-gases circulating through the circulation line; and
a pump disposed on the supply line downstream of the junction portion of the supply line and the circulation line, and
wherein when flooding is detected by the flooding detector, the controller increases the revolution speed of the pump and increases the opening of the first flow regulating valve greater than when flooding does not occur.

3. The fuel cell system according to claim 1 wherein the circulating gas flow regulator comprises:
a first pump disposed on the circulation line; and
a second pump disposed on the supply line downstream of the junction portion of the supply line and the circulation line, and
wherein when flooding is detected by the flooding detector, the controller increases the revolution speed of the first and second pumps greater than when flooding does not occur.

4. The fuel cell system according to claim 2 wherein the circulating gas flow regulator further comprises:
a second flow regulating valve disposed on the supply line upstream of the junction portion of the supply line and the circulation line, for regulating the flow of the oxidant gas, and
wherein when flooding is detected by the flooding detector, the controller decreases the opening of the second flow regulating valve less than when flooding does not occur.

5. The fuel cell system according to claim 1, the fuel cell system further comprising:
an exhaust line for expelling to the outside cathode off-gases expelled from the cathode; and
a back pressure control valve disposed on the exhaust line, for controlling back pressure,
wherein when flooding is detected by the flooding detector, the controller increase the opening of the back pressure control valve greater than when flooding does not occur.

6. The fuel cell system according to claim 1 wherein the flooding detector includes a voltage sensor for detecting cell voltage of the fuel cell.

7. The fuel cell system according to claim 1 wherein the flooding detector includes an impedance meter for measuring AC impedance of the fuel cell.

8. A method for controlling a fuel cell system,
the fuel cell system having: a fuel cell employing a solid polymer electrolyte as the electrolyte membrane; a supply line for supplying oxidant gas to the cathode of the fuel cell; and a circulation line for circulating to the supply line cathode off-gases that were expelled from the cathode,
the method comprising the steps of:
(a) detecting that flooding occur in the fuel cell; and
(b) when flooding is detected, increasing the flow of cathode off-gases circulating through the circulation line greater than when flooding does not occur.

9. The method for controlling a fuel cell system according to claim 8 wherein the fuel cell system further includes an exhaust line for expelling to the outside cathode off-gases expelled from the cathode, and
the method further comprises the step of
(d) when flooding is detected, reducing back pressure within the exhaust line to a lower level than when flooding does not occur.
